(19) United States
(12) Patent Application Publication
(10) Pub. No.: US 2026/0024041 A1
(43) Pub. Date: Jan. 22, 2026

(54) SMART PACKAGE LOCATING SYSTEM

(71) Applicant: GHE Solution Inc., Fremont, CA (US)

(72) Inventors: Xinhuai YANG, Fremont, CA (US); Guanghua LIU, Potomac, MD (US)

(21) Appl. No.: 19/098,575

(22) Filed: Apr. 2, 2025

Related U.S. Application Data
(60) Provisional application No. 63/671,940, filed on Jul. 16, 2024.

(51) Int. Cl. G06Q 10/0833; G08B 7/06; G08B 21/24; H04W 4/029; H04W 4/80

(52) U.S. Cl. CPC G06Q 10/0833; G08B 7/06; G08B 21/24; H04W 4/029; H04W 4/80

(57) ABSTRACT

Aspects described herein may facilitate easy and speedy package locating and delivery. A computing device may receive information comprising a device identifier of a smart tag attached to the package and location information of the delivery site. The computing device may determine a current location of a vehicle is within a geographical area associated with the delivery site, wherein the vehicle carries the package. The computing device may cause the smart tag to output a first audio or visual signal and a smart doorplate, associated with the delivery site, output a second audio or visual signal. In this way, the package locating and delivery process may be streamlined.

### CROSS-REFERENCE TO RELATED APPLICATIONS

This application claims the benefit of U.S. Provisional Application No. 63/671,940, filed on Jul. 16, 2024. The above-referenced application is hereby incorporated by reference in its entirety.

### FIELD OF USE

Aspects of the disclosure relate generally to electronic communications. More specifically, aspects of the disclosure may provide for systems and methods for locating packages and/or delivery sites using electronic devices.

### BACKGROUND

In traditional last-mile delivery where packages are delivered by a delivery truck to their destinations, drivers need to find the packages from the vehicle manually at each delivery site. That process is time-consuming because there are usually hundreds of packages on the vehicle and the address is typed in small font. Another time-consuming task that often wastes time is to find the exact delivery site in a neighborhood, especially at night when the doorplate is difficult to see. A more efficient way to facilitate the last-mile delivery process is needed.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

The two largest time-consuming tasks during last-mile delivery are the process of locating the packages on a delivery vehicle and the process of locating the delivery site in the neighborhood. Locating packages may be challenging because there are often a large number of packages loaded on a delivery vehicle, and the order in which the packages are organized may not necessarily be according to the order in which the packages are to be delivered. For example, the packages may be organized based on their size in order to save space. Sometimes a package to be delivered may be hidden behind another package that is to be delivered at a later time and therefore difficult to view. Sometimes the order of the packages, even organized based on the delivery order, may be messed up when the driver moves them around. The addresses are usually typed in small font and difficult to read without being held closely to the driver, which may further reduce the efficiency of locating the packages. If multiple packages are to be delivered to the same location, one or more packages may be accidentally omitted by the driver at the first delivery attempt and the driver may need to drive back to the delivery site for a second time. Locating the delivery site may also be challenging, for example, especially in neighborhoods where buildings or units are close to each other. At night, locating the delivery site may be more challenging because the doorplate is difficult to see at a distance. Other challenges for last-mail delivery may involve misplacing of the packages, the packages being lost during the delivery without the knowledge of the driver, or the time wasted on operating overly cumbersome processes on work phones or PDAs.

To overcome limitations in the prior art described above, and to overcome other limitations that will be apparent upon reading and understanding the present specification, aspects described herein are directed towards locating packages and/or delivery sites using electronic devices. As described herein, a computing device may monitor the location of a vehicle that carries the packages. The computing device may send instructions to a smart tag attached to the package when the current location of the vehicle is adjacent to the delivery site of the package, so that the smart tag may output a signal (e.g., light or sound) to facilitate the driver quickly identify the package. Additionally or alternatively, the computing device may send instructions to a smart doorplate at the delivery site, so that the smart doorplate may output another signal (e.g., light or sound) to facilitate the driver to quickly identify the delivery site. If there are multiple delivery sites nearby, the computing device may assign different signal patterns (e.g., light of different colors or different flashing patterns) to different delivery sites, and send instructions to the smart tags and corresponding delivery sites accordingly to facilitate the matching between packages and delivery sites. The package and/or delivery site locating process may be improved.

In at least some aspects, a computing device may receive information associated with a package to be delivered. The information may comprise a device identifier of a smart tag attached to the package and location information of the delivery site. The computing device may determine that a current location of a vehicle is within a geographical area associated with the delivery site. Based on the determination, the first computing may send an instruction to the smart tag to output a first audio or visual signal. The computing device may send an instruction to a smart doorplate, associated with the delivery site, to output a second audio or visual signal.

In at least some aspects, the computing device may be a portable or wearable user device, the smart tag may be an Internet of Things (IoT) device, or the smart doorplate may be an IoT device. In at least some aspects, the first audio or visual signal may comprise a light of a first color, and the second audio or visual signal may comprise a light of the first color.

In at least some aspects, the vehicle may further carry a second package. The computing device may further receive second information associated with the second package, determine that the current location is further within a second geographical area associated with a second delivery site where the second package is to be delivered, and based on the determination, cause a second smart doorplate, attached to the second package, to output a light of a second color, wherein the second color is different from the first color.

In at least some aspects, the computing device may determine the current location of the vehicle being within a geographical area associated with the delivery site based on at least one of: global positioning system (GPS); motion detection; or a near-distance communication between the smart doorplate at the delivery site and the computing device.

In at least some aspects, the computing device may further associate, based on the receiving the information, the smart tag and the delivery site. After delivery of the package to the delivery site, the computing device may dissociate the smart tag and the delivery site.

In at least some aspects, the computing device may further determine that the smart tag, attached to the package, is disconnected from the computing device before the package is delivered. The computing device may send an alert indicating the package is lost.

In at least some aspects, the computing device may further determine whether an electronic certificate indicating delivery of the package has been received before the vehicle moves out of the geographical area associated with the delivery site. The computing device may send, based on the electronic certificate had not been received before the vehicle moved out of the geographical area, an alert indicating the package was delivered incorrectly.

In at least some aspects, the computing device may further, based on the determination that the current location is within the geographical area associated with the delivery site, cause a wearable user device to output a third audio or visual signal. The third audio or visual signal may comprise a light corresponding to the first audio or visual signal.

In at least some aspects, the delivery site may be identified based on a Bluetooth identifier of the smart doorplate. The smart doorplate may be attached to a structure at the delivery site.

In at least some aspects, the computing device may further determine that the current location of the vehicle is within a predefined distance of at least two delivery sites. The computing device may determine, based on a respective distance between the current location and each of the at least two delivery sites, a parking location of the vehicle. The predefined distance may be a three-dimensional (3D) distance based on differences in latitude, longitude, and altitude between the current location and the delivery site.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2A is a flow diagram of an example method for delivering packages in accordance with one or more illustrative aspects discussed herein;

FIG. 2B is a flow diagram of another example method for delivering packages in accordance with one or more illustrative aspects discussed herein

FIG. 3 depicts a computing environment in accordance with one or more illustrative aspects discussed herein;

FIG. 4A depicts an example light tag in accordance with one or more illustrative aspects discussed herein;

FIG. 4B depicts an example smart doorplate in accordance with one or more illustrative aspects discussed herein;

FIG. 5 depicts an example communication hub in accordance with one or more illustrative aspects discussed herein;

FIG. 6 is a flow diagram of an example method for locating packages or delivery sites in accordance with one or more illustrative aspects discussed herein;

FIG. 7 is a flow diagram of another example method for locating packages or delivery sites in accordance with one or more illustrative aspects discussed herein;

FIG. 8 depicts an example user interface in accordance with one or more illustrative aspects discussed herein;

FIG. 9 depicts a delivery vehicle with packages in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

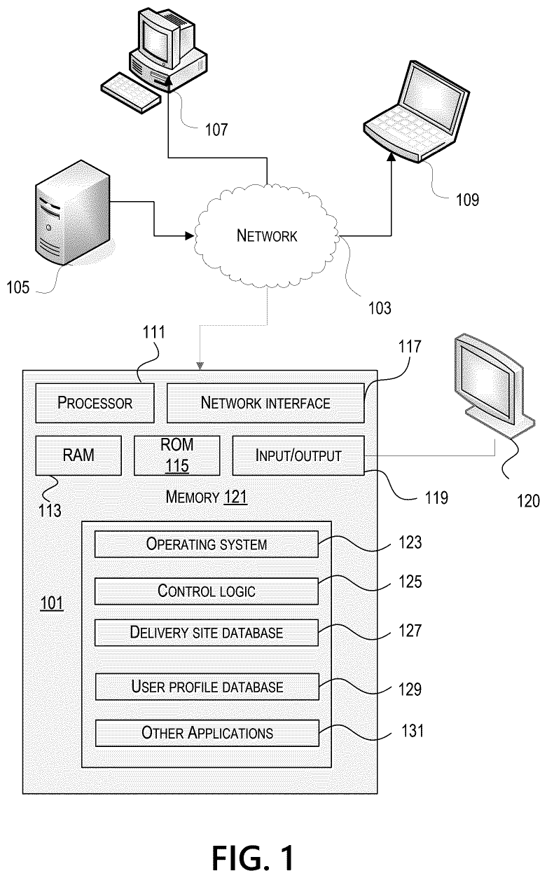

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading or executing instructions and performing one or more actions based on the instructions. In some embodiments, computing device 101 may represent, be incorporated in, or include various devices such as a desktop computer, a computer server, a mobile device (e.g., a laptop computer, a tablet computer, a smartphone, any other type of mobile computing devices, and the like), or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 mloay include one or more computer processing units (CPUs), graphical processing units (GPUs), or other processing units such as a processor adapted to perform computations associating converting information, routing copies of messages, or other functions described herein. I/O 119 may include a variety of interface units and drives for reading, writing, displaying, or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling the overall operation of the computing device 101, control logic 125 for instructing computing device 101 to perform aspects discussed herein. Furthermore, memory 121 may store various databases and applications depending on the particular use, for example, delivery site database 127, user profile database 129, and other applications 131 may be stored in a memory of a computing device used at a server system that will be described further below. Control logic 125 may be incorporated in or may comprise a linking engine that updates, receives, or associates various information stored in the memory 121. In other embodiments, computing device 101 may include two or more of any or all of these components (e.g., two or more processors, two or more memories, etc.) or other components or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125.

One or more aspects discussed herein may be embodied in computer-usable or readable data or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer-readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field-programmable gate arrays (FPGA), and the like. Particular data structures may be used to more effectively implement one or more aspects discussed herein, and such data structures are contemplated within the scope of computer-executable instructions and computer-usable data described herein. Various aspects discussed herein may be embodied as a method, a computing device, a data processing system, or a computer program product.

The data transferred to and from various computing devices may include secure and sensitive data, such as confidential documents, customer personally identifiable information, and account data. Therefore, it may be desirable to protect transmissions of such data using secure network protocols and encryption, or to protect the integrity of the data when stored on the various computing devices. A file-based integration scheme or a service-based integration scheme may be utilized for transmitting data between the various computing devices. Data may be transmitted using various network communication protocols. Secure data transmission protocols or encryption may be used in file transfers to protect the integrity of the data such as, but not limited to, File Transfer Protocol (FTP), Secure File Transfer Protocol (SFTP), or Pretty Good Privacy (PGP) encryption. In many embodiments, one or more web services may be implemented within the various computing devices. Web services may be accessed by authorized external devices and customers to support input, extraction, and manipulation of data between the various computing devices. Web services built to support a personalized display system may be cross-domain or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, or firewalls. Such specialized hardware may be installed and configured in front of one or more computing devices such that any external devices may communicate directly with the specialized hardware.

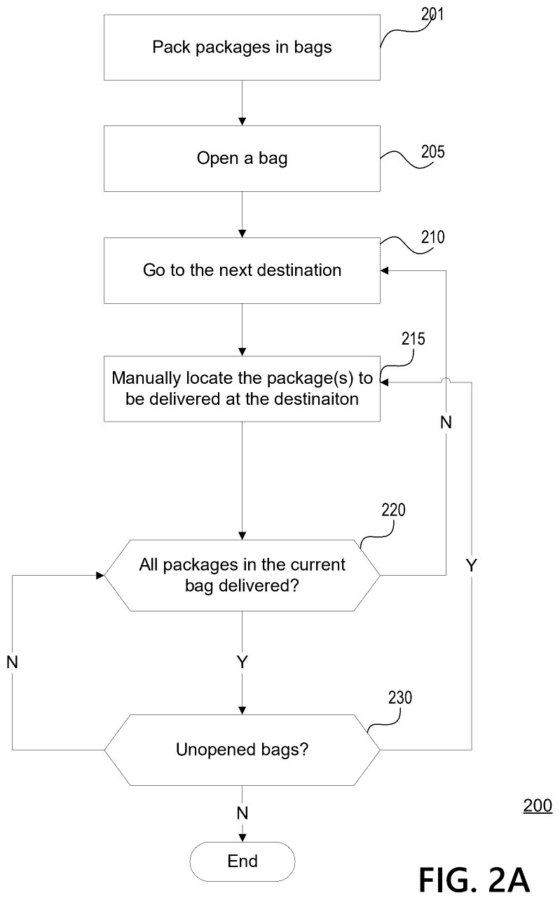

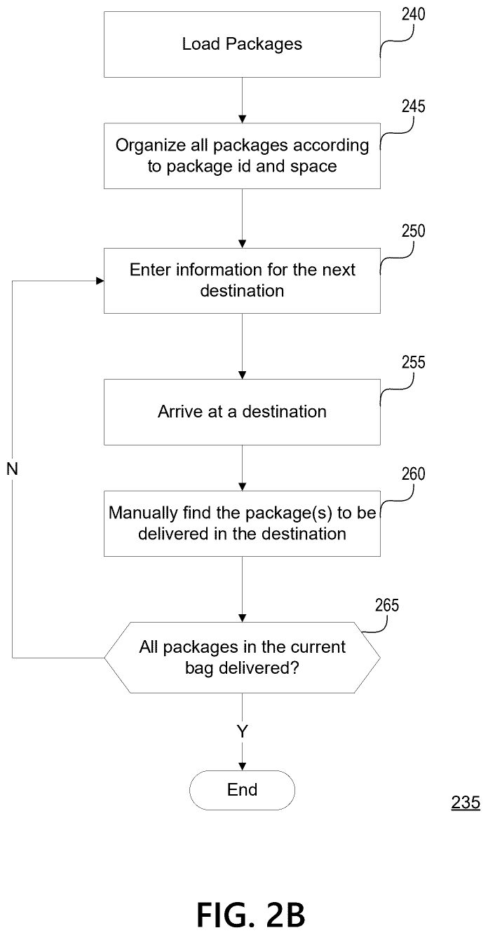

FIG. 2A depicts an example method 200 for delivering packages in at least some systems. Referring to FIG. 2A, in at least some delivery processes, the packages are packed into large bags (e.g., totes) (step 201). For example, a delivery vehicle may carry 200-400 packages and those packages may be packed into 15-20 bags. After the driver loads the bags on the delivery vehicle, the driver may open one bag (step 205) and then drive to the first delivery site (step 210). After arrival, the driver may manually locate the package(s) to be delivered at the first delivery site (step 215). The driver may decide whether all packages in the currently opened bag have been delivered (step 220). If some packages in the opened bag have not been delivered yet, the driver may go to the next delivery site (step 210) and keep the process until all the packages in the opened bag have been delivered. After all packages in the bag have been delivered, the driver may determine whether there are other unopened bags (step 230). If at least one bag has not been opened, the driver may open the next bag and repeat steps 205-220 until all the bags have been opened and all packages have been delivered. However, because packages may come from different warehouses and have different sorting times, packages at the same address and adjacent addresses may be loaded into different bags, resulting in many round trips of deliveries. During the process, the time on performing the following tasks may be wasted: 1) the time on finding the package in the vehicle after each stop; 2) the time on clicking the work phone or PDA to find the delivery number; 3) the time on manually searching the next stop to avoid round trip (if performed); 4) the time on opening bags and organize packages in order; 5) the time on folding bags and returning them to the delivery station; 6) the multi-round-trip time caused by packages of the same or adjacent addresses being loaded to different bags; 7) the multi-round-trip time caused by not finding the package in time; and/or 8) the time consumed due to the work phone crashing and restarting after frequent operation.

FIG. 2B depicts another example method 235 for delivering packages in at least some other systems. In the process depicted in FIG. 2B, all packages are directly loaded in the vehicle (step 240) without being packed into separate bags. The driver may organize the packages according to package identifiers and space in the vehicle (step 245). The driver may enter information for the next destination (step 250). After the driver arrives at the destination (step 255), the driver may manually locate the package(s) to be delivered (step 260). The driver may determine whether all packages on the vehicle have been delivered (step 265), and if not, steps 250 to 260 may be repeated. However, at least the following problems may exist. For example, when the vehicle makes a sharp turn or brakes suddenly, the packages may drift from the organized position and leave the original position, which may increase the difficulty for the driver to find the target package after parking. The driver may need to organize the packages repeatedly many times a day. The following times may be wasted. 1. The time on finding the package in the vehicle after each stop according to the stickers. 2. The time spent on repeatedly organizing the packages, and the first-time organization may take more than a half hour. Usually in plain cities, drivers may organize packages 3-4 times a day. If it is in mountainous areas, drivers may organize packages 6-7 times a day to facilitate finding packages when parking. 3. The time for checking PDA to find the delivery numbers of target packages. 4. The multi-round-trip time caused by not finding the package on time. 5. The time consumed due to the work phone crashing and restarting after frequent operations.

In addition to the problems discussed above, drivers may have difficulty in finding the destination. Inaccurate navigation data also contribute to the problem. Many doorplates may be difficult to view either because the doorplates are dark or because the doorplates are often blocked by trees and shrubs, preventing drivers from finding the exact destination quickly. The drivers may need to slow down in advance and drive while looking around for the doorplates. Since the driver may be distracted, it may also be unsafe. It may be especially difficult to find the destination at night. When drivers deliver at night in mountainous areas, it may be even more difficult to find the destination. In addition, there may be no mobile signals on mobile phones or PDAs in mountainous areas, making the drivers difficult to ask for help or call customers.

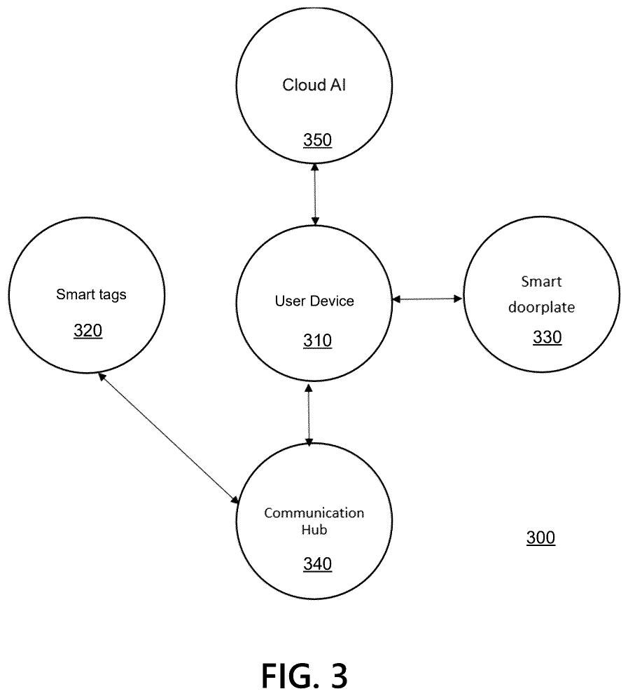

As described herein, a computing device (e.g., a user device 310 depicted in FIG. 3 below) may monitor the location of a vehicle that carries the packages. The computing device may send instructions to a smart tag attached to the package when the current location of the vehicle is adjacent to the delivery site of the package, so that the smart tag may output a signal (e.g., light or sound) to facilitate the driver quickly identify the package. Additionally or alternatively, the computing device may send instructions to a smart doorplate at the delivery site, so that the smart doorplate may output another signal (e.g., light or sound) to facilitate the driver to quickly identify the delivery site. If there are multiple delivery sites nearby, the computing device may assign different signal patterns (e.g., light of different colors or different flashing patterns) to different delivery sites, and send instructions to the smart tags and corresponding smart doorplates accordingly to facilitate the matching packages and delivery sites. The package locating process may be improved, delivery time may be reduced, and user experience may be improved. Additionally or alternatively, since the packages to be delivered at a specific delivery site are easy to locate based on the signal output by the smart tag, the organization of the packages may be improved. For example, the location of packages in the vehicle may be based on the availability of space and/or order of the packages being received, and the need to organize the packages based on the delivery site may be reduced. Space utilization and loading efficiency may be improved.

Referring to FIG. 3, a computing system 300 may comprise a user device 310, a plurality of smart tags 320, a plurality of smart doorplates 330, a communication hub 340, and a cloud computing system 350. Each of the devices in the computing system 300 may be implemented by one or more computing devices 101 as depicted in FIG. 1.

The user device 310 may be associated with a driver that performs delivery tasks. The user device 310 may comprise a wearable user device (e.g., a smartwatch). Additionally or alternatively, the user device 310 may comprise any other types of electronic devices associated with a user, including but not limited to a smartphone, tablet computer, personal digital assistant (PDA), laptop computer, or any other portable or non-portable computing device with network connectivity. The user device 310 may comprise more than one device. For example, The user device 310 may comprise a smart phone and a watch communicatively connected to the smart phone. The user device 310 may be connected to a cloud system 350 (e.g., an artificial intelligence system) to facilitate a variety type of calculations as described herein, including but not limited to intelligent route design to calculate the best route to deliver all packages on a vehicle, parking location calculation, and any other types of calculations.

Each of the plurality of smart tags 320 may comprise an Internet of Things (IoT) device or any other type of electronic device that is capable of communicating with the user device 310, including but not limited to a radio-frequency identification (RFID) tag, Bluetooth Low Energy (BLE) tag, near-field communication (NFC) tag, ultra-wideband (UWB) tag, Wi-Fi-enabled tag, or other wireless transceiver-equipped device. The smart tag 320 may be capable of outputting audio or visual signals based on instructions received from the user device 310. The smart tag may be an ultra-low power consumption device.

The smart tag 320 may communicate with the user device 310 directly via a connection or the smart tag 320 may communicate with the user device 310 via an intermediate device such as a communication hub 340. For example, the communication hub 340 may communicate with the user device 310 via a protocol (e.g., Wi-Fi, Bluetooth) supported by the user device 310, and may communicate with the smart tags 320 via another protocol.

Each of the plurality of smart tags 320 may be attached to a corresponding package, and be associated with a delivery site of the package. As described in greater detail below, the smart tag 320 may receive instructions from the user device 310 to output audio or visual signals to facilitate the driver to quickly locate the package when the driver arrives at the delivery site. For example, the audio or visual signal may include but is not limited to a light of a specific color, a light flashing in a specific pattern, a beeping sound, a music. Other types of audio or visual signals are possible.

The user device 310 may communicate with a plurality of smart doorplates 330. The smart doorplate 330 may comprise an Internet of Things (IoT) device or any other type of electronic device that is capable of communicating with the user device 310, including but not limited to a radio-frequency identification (RFID) device, Bluetooth Low Energy (BLE) device, near-field communication (NFC) device, ultra-wideband (UWB) device, Wi-Fi-enabled device, or other wireless transceiver-equipped device. A smart doorplate 330 may be associated with a delivery site. For example, a smart doorplate 330 may be attached to a premise or a mailbox. The smart doorplate 330 may comprise a light showing at least a portion of the address (e.g., street number) of the delivery site. The smart doorplate 330 may be capable of outputting audio or visual signals based on instructions received from the user device 310. For example, the smart doorplate 330 may output a light showing the street number of the delivery site after receiving the instruction from the user device 310 to facilitate the driver to quickly locate the delivery site, as described in further detail below. The smart doorplate may be an ultra-low power consumption device.

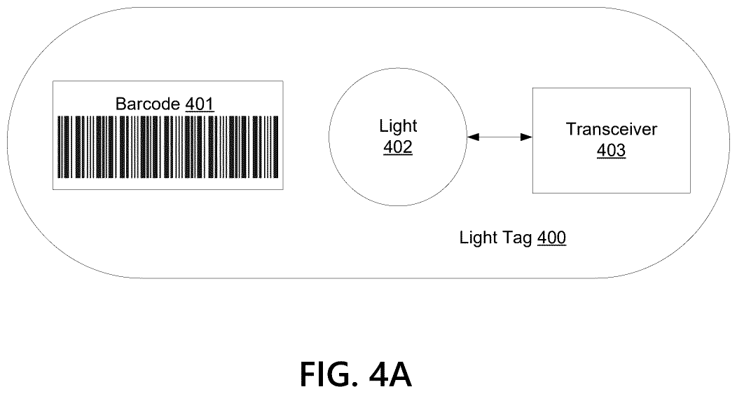

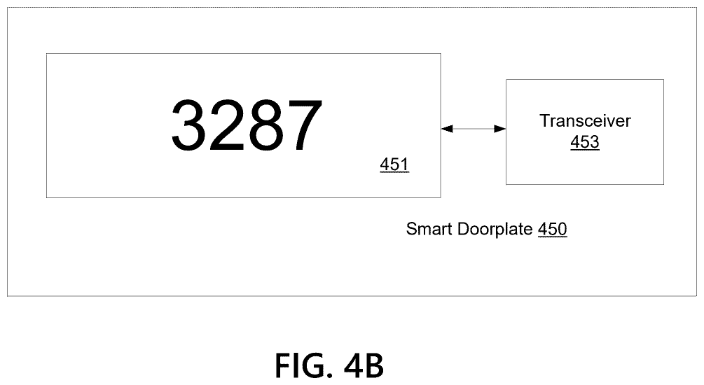

FIG. 4A depicts a light tag 400 as an example of a smart tag 320 as depicted in FIG. 3. As shown in FIG. 4A, the light tag 400 may comprise a barcode 401, light 402 (e.g., a group of LED lights), and a transceiver 403. The barcode 401 may be configured to identify the light tag 400 and may indicate a device identifier of the light tag 400. The light 402 may be configured to output light of different colors and/or different flashing patterns based on instructions (e.g., instructions received from the user device 310). The transceiver 403 may be configured to receive instructions from the user device 310 (e.g., either directly or via the communication hub 340) and/or transmit response signals (e.g., to verify connection as described below) to the user device 310.

FIG. 4B depicts a smart doorplate 450 as an example of a smart doorplate 330 depicted in FIG. 3. As shown in FIG. 4B, the smart doorplate 450 may comprise light 451 (e.g., a group of LED lights) and a transceiver 453. The light 451 may indicate at least a portion of the address associated with the delivery site where the smart doorplate 450 is attached. For example, the light 451 may indicate the street number “3287” as depicted in FIG. 4B. The light 451 may be capable of outputting different colors and/or different flashing patterns based on instructions. The transceiver 453 may be configured to receive instructions from the user device 310 and/or transmit response signals to the user device 310.

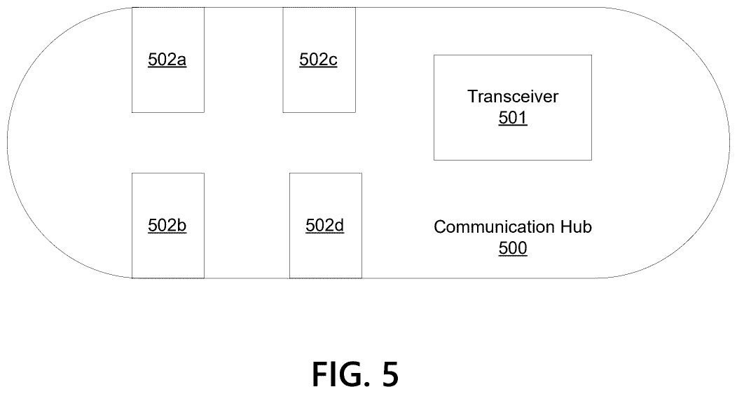

FIG. 5 depicts a communication hub 500 as an example of the communication hub 340 as depicted in FIG. 3. The communication hub 500 may comprise a transceiver 501 to communicate with the user device 310 and/or the plurality of smart tags 320. The transceiver configured 501 may support more than one communication protocol, for example, if the user device 310 and the smart tags 320 use different communication protocols. The communication hub 500 may be configured to relay instructions from the user device 310 to the smart tags 320, and/or relay messages from the smart tags 320 to the user device 310. The communication hub 500 may be configured to perform other functions to facilitate the operation of the smart tags 320. For example, the communication hub 500 may include charging stations (502a, 502b, 502c, and 502d) to charge the smart tags 320. It is appreciated that any other numbers of charging stations and any other layout of the charging stations are possible.

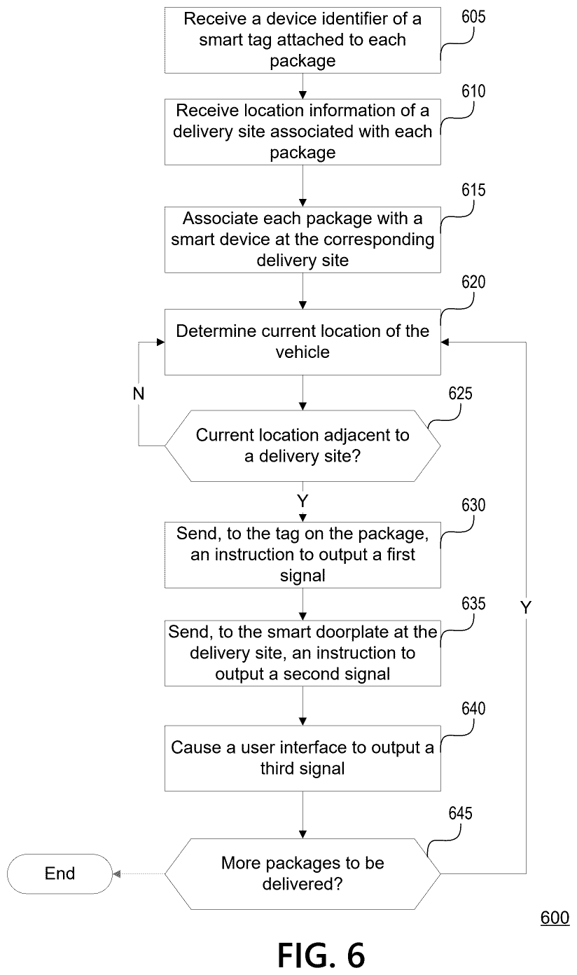

FIG. 6 is a flow diagram depicting a method 600 for locating packages and/or delivery sites in accordance with one or more illustrative aspects discussed herein. The steps in method 600 may be performed by a system comprising, for example, a computing system 300 may comprise a user device 310, a plurality of smart tags 320, a plurality of smart doorplates 330, a communication hub 340, and a cloud computing system 350. Additionally or alternatively, the steps in method 600 may be performed by other computing devices.

At step 605, a computing device may receive information associated with each of a plurality of packages to be delivered. The plurality of packages may be carried by a vehicle and delivered from the warehouse to the delivery sites. The information of each package may comprise a device identifier of a smart tag 320 attached to the package. The computing device may comprise the user device 310 and/or the communication hub 340 depicted in FIG. 3. Additionally or alternatively, the computing device may comprise other computing devices, for example, a computing device associated with a package delivery station. The computing device may be a computing system comprising more than one device.

The plurality of packages may comprise packages loaded or to be loaded to a delivery vehicle (e.g., a delivery truck). Each smart tag may 320 be physically attached to a package to be delivered (e.g., using a clip, a magnate sticker, etc.). The computing device may receive an identifier of the smart tag 320, for example, by scanning a barcode 401 on the smart tag 400 as depicted in FIG. 4A. The device identifier of the smart tag 320 may be associated with the package it attaches to until the delivery is completed.

At step 610, the computing device may receive information comprising location information of a respective delivery site corresponding to each package. For example, the computing device may receive the location information by scanning the delivery instructions (e.g., including mailing address information) on the package.

At step 615, the computing device may associate each package with a smart doorplate 330 at the corresponding delivery site. For example, the computing device may store (e.g., in a database communicatively connected to the user device 310) a device identifier of each smart doorplate 330, and associate the device identifier of the smart doorplate 330 with the address of the delivery site where the smart doorplate 330 is attached. For example, the device identifier may be a Bluetooth identifier, a media control access (MAC) address, or any other type of identifier. The computing device may also associate the smart tag attached to a package with the smart doorplate where the package is to be delivered. For example, packages A and B may be delivered to delivery site 1, and package C may be delivered to delivery site 2. The computing device may store a map that maps the smart tags attached to packages A and B with the smart doorplate at delivery site 1, and/or maps the smart tag attached to package C with the smart doorplate at delivery site 2. If a delivery site does not have a smart doorplate, the computing device may map the smart tag with the address without mapping the smart tag to a smart doorplate.

One or more steps 605 to 615 may be performed before or after the packages are loaded into the delivery vehicle. For example, one or more steps of 605 to 615 may be performed at the delivery station before the packages are loaded into the vehicle. One or more steps of 605 to 615 may be performed simultaneously to or after the packages are loaded into the vehicle.

At step 620, the computing device may determine the current location of the vehicle, for example, while the vehicle is moving. For example, the computing device may be in the vehicle (e.g., a phone or a smartwatch of the driver) and the computing device may determine the location of itself. In another example, the computing device may be located outside the vehicle and determine the current location of the vehicle via a tracker in the vehicle. For simplicity, the below description refers to an example in which the computing device is in the vehicle, but it is appreciated that a tracker communicatively connected with the computing device may be used.

The current location may be determined in real time. For example, the current location may be determined based on global positioning system (GPS) and/or motion detection techniques. The GPS module may comprise one or more high-sensitive and high-gain antennas, one or more altitude sensors, one or more cameras camera compatible with autofocus and fixed focal length, and one or more G-Sensor motion detection sensors. The GPS module may quickly and accurately locate the current location of the vehicle. Additionally or alternatively, the current location may be determined based on a near-distance communication between the smart doorplate at the delivery site and the computing device. For example, if a near-distance communication connection between the smart doorplate at a delivery site and the computing device is established, the computing device may determine that the vehicle is within a pre-defined distance from the delivery site. The predefined distance is a three-dimensional (3D) distance based on differences in latitude, longitude, and altitude between the current location and the delivery site.

The computing device may also calculate the route and plan the destination based on all delivery sites where packages on the vehicle are to be delivered, to instruct the vehicle to travel according to the shortest route or the route that takes the least time for the entire trip. The route calculation may take account of the 3D travel distance.

At step 625, the computing device may determine whether the current location of the vehicle is adjacent to any of the plurality of delivery sites. For example, the current location of the vehicle may be determined as adjacent to a delivery site if the vehicle is within a predefined geographical area associated with the delivery site or within a predefined distance from the delivery site. The predefined geographical area and/or distance may be determined based on various factors. For example, the geographical area and/or distance may be configured based on the preference of the driver. If a driver prefers to walk more, the current location may be determined as adjacent to the delivery site when the vehicle and the delivery site are relatively far away (e.g., 50 feet from each other). If the driver prefers to walk less, the current location may be determined as adjacent to the delivery site after the vehicle and the delivery site get closer (e.g., 20 feet from each other). The geographical area and/or distance may be refined based on the circumstances of the delivery site. For example, if a premise is able to accessed from the front door but not from the backyard, then the current location of the vehicle may be determined as adjacent to the delivery site if the vehicle is close to the front door, but not determined as adjacent if the vehicle is close to the backyard. This may be helpful to further pinpoint the parking location of the vehicle.

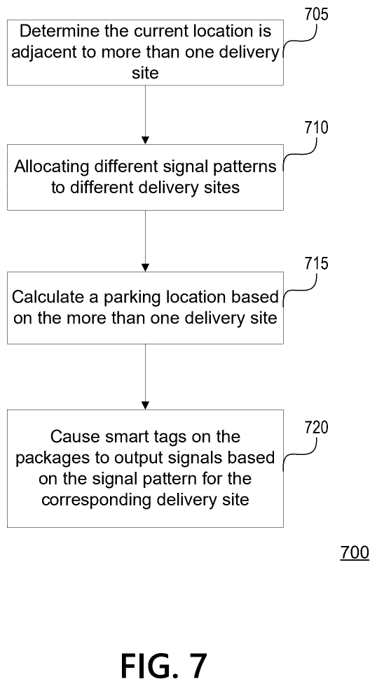

If the computing device determines that the current location is not adjacent to any of the delivery sites, the computing device may keep monitoring the current location. If the computing device determines that the current location is adjacent to at least one of the delivery sites, the method may proceed to step 630. As described in further detail in connection with FIG. 7, the current location of the vehicle may be determined as adjacent to more than one delivery site simultaneously.

At step 630, the computing device may send, to the smart tag 320 that is attached to the package, an instruction to output a first signal. The first signal may be an audio signal, a visual signal, or a combination. For example, the first signal may comprise a light or sound. The light may be displayed at a specific color (e.g., red, green, blue) and/or a specific pattern (e.g., a specific flashing pace and/or sequence). The sound may comprise any audible tone, such as beeping, chiming, or a piece of music. The first signal may help the driver to quickly identify the package to be delivered at the current delivery site from a plurality of other packages (e.g., hundreds of other packages) on the vehicle.

At step 635, the computing device may send, to the smart doorplate 330 at the delivery site, an instruction to output a second signal. The second signal may be an audio signal, a visual signal, or a combination. For example, the second signal may comprise a light or sound. The light may be displayed at a specific color (e.g., red, green, blue) and/or a specific pattern (e.g., a specific flashing pace and/or sequence). The sound may comprise any audible tone, such as beeping, chiming, or a piece of music. The second signal may help the driver to quickly identify the delivery site from its neighborhood. This may be helpful, for example, in a crowded neighborhood where multiple delivery sites are close to each other. Light signal may also be helpful particularly when it is dark outside. Sound signal may be helpful particularly when there is a likelihood that the doorplate is blocked by obstructions (e.g., trees, bushes) in the neighborhood.

The second signal may correspond to the first signal. For example, the light output by the smart tag and corresponding smart doorplate may be of the same color. For example, the smart tags on packages to be delivered at delivery site 1 may output a blue light, while smart tags on packages to be delivered at delivery site 2 may output a red light. The smart doorplate at delivery site 1 may output a blue light, and the doorplate at delivery site 2 may output a red light. As described in connection with FIG. 7, this may be helpful particularly if multiple delivery sites are nearby.

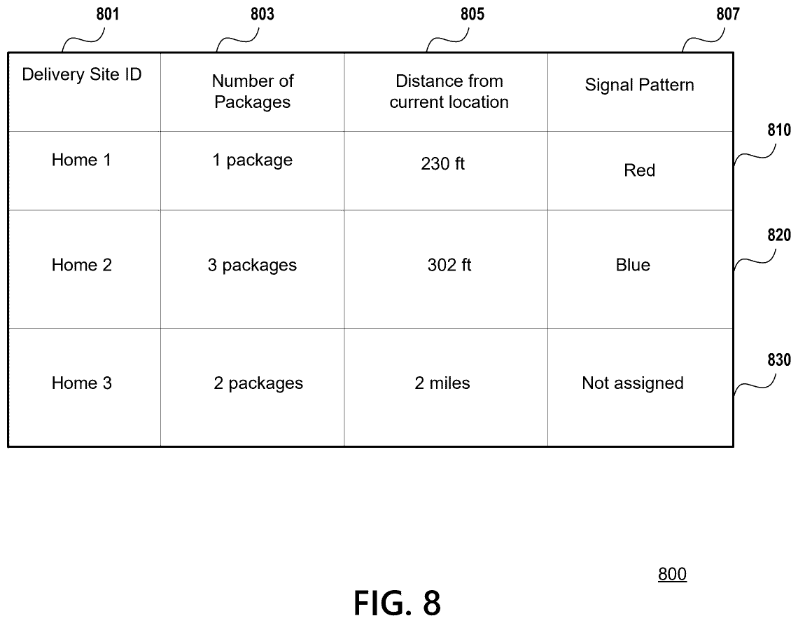

At step 640, the computing device may cause a graphical user interface to output a third signal. The third signal may be a notification to the user to stop the vehicle to deliver one or more packages, and may indicate the information associated with the delivery site, as further described in connection to FIG. 8 below.

After the vehicle is stopped within a geographical location associated with a delivery site, the computing device may determine whether an electronic certificate is received before the vehicle moves out of the geographical area associated with the delivery site. The electronic certificate may indicate a successful delivery of the package. The electronic certificate may be authorized by a user at the delivery site and indicate the user's reception of the package. If the computing device determines that the vehicle moves out of the geographical area before receiving the electronic certificate, the computing device may send, based on the electronic certificate had not been received before the vehicle moved out of the geographical area, an alert indicating the package was delivered incorrectly.

Before successfully delivery of the package, the computing device may establish a connection with the smart tag 320. The connection may be established between the user device 310 (e.g., driver's watch or cellphone) and the smart tag 320, or between a communication hub 340 and the smart tag 320. The computing device may determine, for example, periodically, whether the connection is maintained before the package is successfully delivered. For example, the computing device may send periodic heartbeat messages to check the status of the connection and determine whether responses from the smart tag 320 are timely received. If the computing device determines that no response was received from the smart tag 320 for a period of time exceeding a threshold, the computing device may determine the package to which the smart tag 320 is attached has been lost or delivered incorrectly. The computing device may cause an alert to be displayed on the user device 310 to prompt the driver to confirm whether the package is still in the driver's possession. This may help prevent packages from being lost during the delivery process.

After delivery of the package to the delivery site, the computing device may dissociate the smart tag from the delivery site, for example, by deleting the mapping between the smart tag and the address and/or smart doorplate of the delivery site from the database. This way, the smart tag may be reused for other packages (attached to new packages and associated with other delivery sites).

At step 645, the computing device may determine whether more packages are to be delivered. For example, the computing device may determine whether all the smart tags associated with packages in the vehicle have been dissociated with the delivery site, and/or whether an input confirmation (e.g., by the driver) that confirms delivery of all packages has been received. If the computing device determines that more packages are to be delivered, the method may proceed back to step 620, where the computing device may display the next destination and keep monitoring the current location of the vehicle while the vehicle is heading to the next destination.

The steps of method 600 may be modified, omitted, or performed in other orders, or other steps added as appropriate.

FIG. 7 is a flow diagram depicting a method 700 for locating packages and/or delivery sites in accordance with one or more illustrative aspects discussed herein. The steps in method 700 may be performed by a system comprising, for example, a computing system 300 may comprise a user device 310, a plurality of smart tags 320, a plurality of smart doorplates 330, a communication hub 340, and a cloud computing system 350. The steps in method 700 may be performed in combination with steps in method 600 described in FIG. 6. For example, as explained above, steps in method 700 may be additional steps performed by the computing device based on a current location of the vehicle is adjacent to more than one delivery site.

At step 705, the computing device may determine the current location is adjacent to at least two delivery sites. Step 705 may be implemented as an example of step 625 depicted in FIG. 6, at which the computing device determines that at least one delivery site is adjacent to the current location. For example, the at least two delivery sites may comprise a first delivery site for delivery of a first package and a second delivery site for delivery of a second package.

At step 710, the computing device may allocate different signal patterns to different delivery sites. Different signal patterns may comprise different colors and/or flashing patterns of light, and/or different sounds. The computing device may display, on a graphical user device (e.g., a user device on the driver's phone or watch), the different delivery sites and corresponding signal patterns. Step 710 may be implemented as an example of step 640 depicted in FIG. 6.

FIG. 8 depicts an example user device interface that may be displayed on the user device 310. As shown in FIG. 8, the user interface may comprise a table 800. Table 800 may comprise a plurality of columns, each representing different categories of information. For example, column 801 may indicate a delivery site ID, which may be represented by, for example, the address (either full address or street number) of the delivery site, the smart doorplate id, or other suitable information. Column 803 may indicate the number of packages to be delivered to this delivery site. Column 805 may indicate the distance between the delivery site and the current location of the vehicle. Column 807 may indicate the signal patterns allocated to the delivery site. Table 800 may comprise a plurality of rows, each representing information for a delivery site.

For example, both Home 1 and Home 2 may be adjacent to the current location of the vehicle. Row 810 may indicate that one (1) package is to be delivered to Home 1, the current location of the vehicle is 230 ft from Home 1, and that the signal pattern assigned to Home 1 is “Red.” That may indicate that the smart tag attached to the package to be delivered to Home 1 would output a red light, and the smart doorplate at Home 1 would also output a red light. At least some portion of row 810 may be displayed in red to further provide a visual aid to the driver to understand the assigned signal pattern. Row 820 may indicate that three (3) packages are to be delivered to Home 2, the current location of the vehicle is 302 ft from Home 2, and that the signal pattern assigned to Home 2 is “Blue.” That may indicate that the smart tag attached to each of the three packages to be delivered to Home 2 would output a blue light, and the smart doorplate at Home 2 would also output a blue light. At least some portion of row 820 may be displayed in blue to further provide a visual aid to the driver to understand the assigned signal pattern.

Other rows may display other delivery sites that are not adjacent to the current location. For example, row 830 may indicate that two (2) packages are to be delivered to Home 3, the current location of the vehicle is 2 miles from Home 3, and that the signal pattern field may indicate the signal pattern for Home 3 is not assigned yet, because Home 3 is still far away from the current location. That may indicate that the smart tag attached to each of the two packages to be delivered to Home 3 would not output any signals at this time, and/or the smart doorplate at Home 3 would not output any signals at this time. By not having the smart tags attached to other packages to output signals, distraction to the driver may be reduced. At least some portion of row 830 may be displayed in another color, e.g., black or grey, to further indicate the delivery site is not adjacent to the current location. It is appreciated that more columns or fewer columns may be indicated in the user interface.

Referring back to FIG. 7, at step 715, the computing device may calculate a parking location based on the at least two delivery sites, for example, based on a respective distance between the current location and each of the at least two delivery sites. Consistent with the example discussed in connection with FIG. 8, the computing device may determine the parking location to optimize the driver's walking distance to deliver the packages to Home 1 and Home 2. For example, the parking location may be based on the shortest route the driver should walk from the vehicle to Home 1 and then to Home 2. The parking location may be further optimized, for example, based on the package weights, the number of packages, and/or the topographic features in the neighborhood. For example, if the packages to be delivered to Home 1 are heavier and the packages to be delivered to Home 2 are lighter, the parking location may be closer to Home 1 than Home 2. If more packages are to be delivered to Home 1 and fewer packages are to be delivered to Home 2, the parking location may be closer to Home 1 than Home 2. In another example, if Home 1 is on a big slope and Home 2 is not, the parking location may be closer to Home 1 than Home 2.

At step 720, the computing device may cause the smart tags on the packages to output signals based on the signal patterns assigned to the corresponding delivery site. Step 720 may be implemented as an example of steps 630 and 635 depicted in FIG. 6. Consistent with the example described in connection with FIG. 8, the computing device may send an instruction to the smart tag attached to the package to be delivered to Home 1 to output a red light, and send an instruction to the smart doorplate at Home 1 to output a red light. The computing device may send instructions to each of the three smart tags attached to the three packages to be delivered to Home 2 to output a blue light, and send an instruction to the smart doorplate at Home 2 to output blue light.

The steps of method 700 may be modified, omitted, or performed in other orders, or other steps added as appropriate.

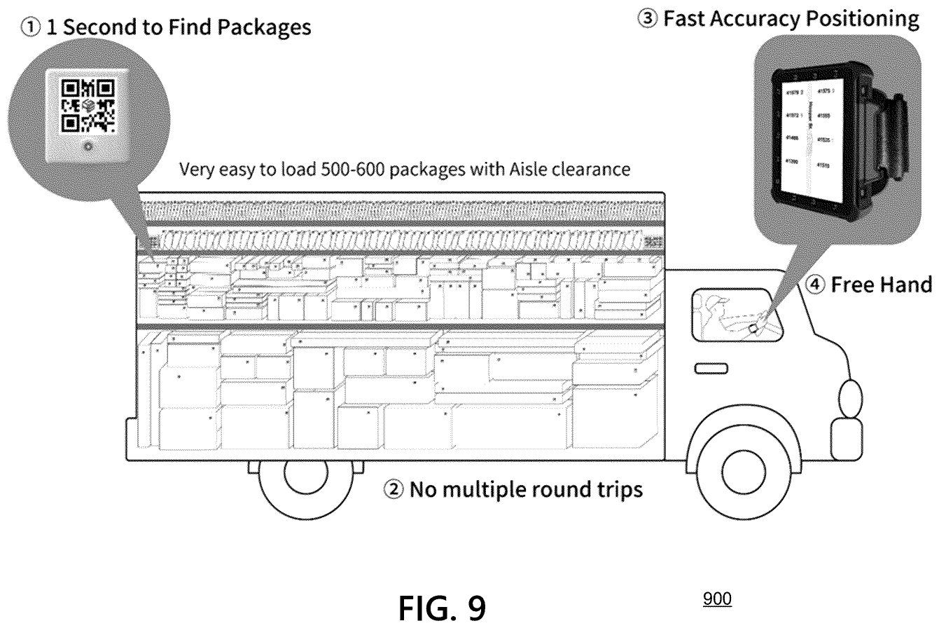

FIG. 9 illustrates a delivery vehicle 900 with packages loaded into the vehicles. As described above, with the smart tags facilitating quickly locating packages, the packages may be organized based on the availability of space. Space utilization and loading efficiency may be improved. The benefit of the delivery system may also include facilitating quickly finding packages to be delivered at a specific delivery site, avoiding multiple round trips. With the user device 310 being a wearable user device, it may also help with fast and accurate positioning of the current location of the vehicle and setting the user's hand free from typing and/or checking various instructions.

Although the subject matter has been described in language specific to structural features or methodological acts, it is to be understood that the subject matter defined in the appended claims is not necessarily limited to the specific features or acts described above.

Rather, the specific features and acts described above are disclosed as example forms of implementing the claims. Accordingly, the scope of the invention should be determined not by the embodiments illustrated, but by the appended claims and their equivalents.

What is claimed is:

1. A method comprising:
receiving, by a computing device, information associated with a package to be delivered, wherein the information comprises:
a device identifier of a smart tag attached to the package; and
location information of a delivery site;
determining a current location of a vehicle is within a geographical area associated with the delivery site, wherein the vehicle carries the package; and
based on the determining:
sending, to the smart tag, an instruction to output a first audio or visual signal; and
sending, to a smart doorplate associated with the delivery site, an instruction to output a second audio or visual signal.

2. The method of claim 1, wherein:
the computing device comprises a portable user device;
the smart tag comprises an Internet of Things (IoT) device; or
the smart doorplate comprises an IoT device.

3. The method of claim 1, wherein the first audio or visual signal comprises a light of a first color, and the second audio or visual signal comprises a light of the first color.

4. The method of claim 3, wherein the vehicle further carries a second package, and wherein the method further comprising:
receiving second information associated with the second package;
determining that the current location is further within a second geographical area associated with a second delivery site where the second package is to be delivered; and
based on the determining, causing a second smart tag, attached to the second package, to output a light of a second color, wherein the second color is different from the first color.

5. The method of claim 1, wherein the determining the current location of the vehicle being within a geographical area associated with the delivery site is based on at least one of:
global positioning system (GPS);
motion detection; or
a near-distance communication between the smart doorplate at the delivery site and the computing device.

6. The method of claim 1, further comprising:
associating, based on the receiving the information, the smart tag and the delivery site; and
after delivery of the package to the delivery site, dissociating the smart tag and the delivery site.

7. The method of claim 1, further comprising:
determining that the smart tag, attached to the package, is disconnected from the computing device before the package is delivered; and
sending an alert indicating the package is lost.

8. The method of claim 1, further comprising:
determining whether an electronic certificate indicating delivery of the package has been received before the vehicle moves out of the geographical area associated with the delivery site; and
sending, based on the electronic certificate had not been received before the vehicle moved out of the geographical area, an alert indicating the package was delivered incorrectly.

9. The method of claim 1, further comprising:
based on the determination that the current location is within the geographical area associated with the delivery site, causing a wearable user device to output a third audio or visual signal, wherein the third audio or visual signal comprises a light corresponding to the first audio or visual signal.

10. The method of claim 1, wherein the delivery site is identified based on a Bluetooth identifier of the smart doorplate, and wherein the smart doorplate is attached to a structure at the delivery site.

11. The method of claim 1, further comprising:
determining that the current location of the vehicle is within a predefined distance of at least two delivery sites; and
determining, based on a respective distance between the current location and each of the at least two delivery sites, a parking location of the vehicle.

12. The method of claim 11, wherein the predefined distance is a three-dimensional (3D) distance based on differences in latitude, longitude, and altitude between the current location and the delivery site.

13. A computing device comprising:
one or more processors;
memory storing instructions, when executed by the one or more processors, configure the computing device to perform actions comprising:
receiving information, associated with a package to be delivered, comprising:
a device identifier of a smart tag attached to the package; and
location information of a delivery site;
determining a current location of a vehicle is within a geographical area associated with the delivery site, wherein the vehicle carries the package; and
based on the determining:
sending, to the smart tag, an instruction to output a first audio or visual signal; and
sending, to a smart doorplate associated with the delivery site, an instruction to output a second audio or visual signal.

14. The computing device of claim 13, wherein:
the computing device comprises a portable user device;
the smart tag comprises an Internet of Things (IoT) device; or
the smart doorplate comprises an Internet of Things (IoT) device.

15. The computing device of claim 13, wherein the first audio or visual signal comprises a light of a first color, and the second audio or visual signal comprises a light of the first color.

16. The computing device of claim 15, wherein the vehicle further carries a second package, and wherein the instructions, when executed by the one or more processors, further configure the computing device to perform actions comprising:
receiving second information associated with the second package;
determining that the current location is further within a second geographical area associated with a second delivery site where the second package is to be delivered; and
based on the determining, causing a second smart tag, attached to the second package, to output a light of a second color, wherein the second color is different from the first color.

17. A system comprising:
a computing device configured to perform actions comprising:
receiving information, associated with a package to be delivered, comprising:
a device identifier of a smart tag attached to the package; and
location information of the delivery site;
determining a current location of a vehicle is within a geographical area associated with the delivery site, wherein the vehicle carries the package; and
based on the determining:
sending, to the smart tag, an instruction to output a first audio or visual signal; and
sending, to a smart doorplate associated with the delivery site, an instruction to output a second audio or visual signal; and
the smart tag configured to output the first audio or visual signal; and
the smart doorplate configured to output the second audio or visual signal.

18. The system of claim 17, wherein:
the computing device comprises a portable user device;
the smart tag comprises an Internet of Things (IoT) device; or
the smart doorplate comprises an Internet of Things (IoT) device.

19. The system of claim 17, wherein the first audio or visual signal comprises a light of a first color, and the second audio or visual signal comprises a light of the first color.

20. The system of claim 17, wherein the vehicle further carries a second package, and wherein the computing device is further configured to perform actions comprising:
receiving second information associated with the second package;
determining that the current location is further within a second geographical area associated with a second delivery site where the second package is to be delivered;
based on the determining, causing a smart tag, attached to the second package, to output a light of a second color, wherein the second color is different from the first color.
